(19) United States
(12) Patent Application Publication
(10) Pub. No.: US 2008/0045262 A1
(43) Pub. Date: Feb. 21, 2008

(54) Method and Apparatus for Providing Service-Based Cell Reselection

(76) Inventors: Vanvinh Phan, Oulu (FI); Ling Yu, Oulu (FI); Markku Vainikka, Kiviniemi (FI)

Correspondence Address: DITTHAVONG MORI & STEINER, P.C., 918 Prince St., Alexandria, VA, 22314, US

(21) Appl. No.: 11/557,324

(22) Filed: Nov. 7, 2006

(30) Foreign Application Priority Data
Aug. 16, 2006 (EP) EP 06 017 056.0

(51) Int. Cl. H04B 7/00; H04Q 7/20

(52) U.S. Cl. 455/525

(57) ABSTRACT

An approach is provided for cell selection or reselection in a multi-radio network environment involving at least two different radio access technologies. A service preference information which indicates service preferences for different radio access technologies can be set at a network element and be sent to at least one terminal device. At the terminal device, the service preference information is detected and a serving cell is selected based on the detected service preference information. Thereby, the network is capable of performing service-based control of cell selection or reselection of the terminal device upon initiating access for a certain service in an overlaid multi-RAT environment. This in turn enhances network utility, operation and performance.

### FIELD OF THE INVENTION

The invention, according to various embodiments, relates to communications, and particularly, to cell selection or reselection in a multi-radio network environment.

### BACKGROUND OF THE INVENTION

Different generations of mobile communications have been conceived and implemented since the 1980s in a quite independent way from each other. This tendency has in a way been inverted since the middle of the 1990s and beginning of this century, when different groups involved in the design of mobile communications infrastructures started to look for and promote technologies that instead of replacing the previous technologies enabled the synergic cooperation among them with the consequent increase in capacity. Approaches on co-operation between multiple radio access technologies (RATs) in a multi-RAT environment have been investigated.

The availability of multiple access alternatives offers the capability of increasing the overall transmission capacity, providing better service quality and reducing the deployment costs for wireless access. In order to exploit this potential multi-access gain it is required that different RATs are managed in a co-operative fashion. The multi-RAT environment involves a collection of nodes and/or devices which share a common network control plane through which different cooperation levels in resource usage can be reached. In this way, synergic cooperation can be achieved among diverse RATs belonging to the same or different operators. More specifically, the proposed multi-RAT architecture is configured to provide services via access points (APs) belonging to the same or different radio access technologies (RATs) or owners. The coordination between the available RATs and/or resource owners shall be supported and applicable in case of different level of cooperation among the different entities (RATs and/or owners).

Furthermore, the design of the multi-RAT architecture should aim at minimizing the resource usage of terminals devices (e.g., mobile phones, user equipments (UEs), mobile terminals, etc.) in terms of costs, power consumption, and the like. It should also support terminal devices that have simultaneous direct (terminal to terminal) communication and wireless communication with a fixed infrastructure, as well as terminal devices that communicate via intermediate network elements, including fixed and mobile relays, local access points and repeaters. Regarding backward compatibility, the multi-RAT architecture should support both legacy (conventional) and new RATs and furthermore allow smooth integration in standardization and deployment by minimizing the changes to future releases of legacy RATs.

As an example, the long-term evolution (LTE) of the 3GPP (3^{rd} Generation Partnership Project) UTRAN (Universal Mobile Telecommunications System (UMTS) Terrestrial Radio Access Network), also called E-UTRAN is applied for such a multi-RAT environment in which there are multiple overlaid cells using different RATs, e.g., LTE and 3G and/or 2G. It is assumed that these cells are operated in a common or shared administrative domain of the operator(s) and all can be available for the UE to use.

In such an overlaid multi-RAT environment, cell reselection criteria for the UE are of importance for efficient network operation. When camped on a cell, the UE may regularly search for a better cell according to the cell reselection criteria. If a better cell is found, that cell is selected. Further details concerning cell selection and reselection issues of current 3G networks can be found in the 3GPP Technical Specifications (TS) 25.304 and 23.122.

A problem involved in cell selection or reselection is to determine which RAT cell should be used for which service purpose of the UE so that the utility of the network resources is balanced and optimum while providing high quality of service (QoS) to the UE and avoiding inter-RAT handover as much as possible.

### SUMMARY OF SOME EXEMPLARY EMBODIMENTS

Therefore, there is a need to provide a method and system for enabling flexible control of cell reselection to achieve improved resource utilization at high QoS.

According to an embodiment of the invention, a method comprises:
detecting at a terminal device a service preference information indicating service preferences for different radio access technologies; and
selecting based on said detected service preference information a serving cell out of at least two available cells of different radio access technologies.

According to another embodiment of the invention, a method comprises:
setting at a network element a service preference information indicating service preferences for different radio access technologies; and
signaling said service preference information to at least one terminal device.

According to another embodiment of the invention, a respective computer program products comprises code means for producing the above method steps when run on a computer device.

According to another embodiment of the invention, a terminal device comprises:
detecting means for detecting in a downlink signal a service preference information indicating service preferences for different radio access technologies; and
selecting means for selecting based on said detected service preference information a serving cell out of at least two available cells of different radio access technologies.

According to yet another embodiment of the invention, a network element comprises:
setting means for setting a service preference information indicating service preferences for different radio access technologies; and
signaling means for signaling said service preference information to at least one terminal device.

Accordingly, a simple and effective solution is proposed for signaling service-based cell selection or reselection criteria to the terminal device. This enables the network to control the terminal device to access a suitable RAT cell for a certain service in an overlaid multi-RAT environment. The proposed service preference information can be used as a service-based condition for triggering an inter-RAT handover as well. Thus, a simple solution is proposed, which allows the network to control the terminal device upon initiating access for a certain service in an over-laid multi-RAT environment. This in turn enhances network utilization, operation and performance.

The service preference information may be signaled and detected in various kinds of network messages, such as for example in at least one of a received broadcast system information, a capability information confirmation received during a negotiation procedure, a received location update confirmation, and a received paging message for an incoming call. The service preference information may thus be embedded in at least one of a broadcast system information, a capability negotiation with said terminal device, and a network policy enforcement during initial access and registration. In a specific implementation example, the service preference information may be conveyed and subsequently detected in an information element of a radio resource control message.

In an embodiment, the service preference information may indicate a service-dependent priority of a first radio access technology over at least one a second radio access technology.

Furthermore, the selection may be configured to trigger an inter-radio access technology handover. Alternatively or additionally, the inter-radio access technology handover may be prepared from the network side before call set-up

Further advantageous modifications or developments are defined in the dependent claims.

### BRIEF DESCRIPTION OF THE DRAWINGS

The invention will now be described on the basis of various embodiments with reference to the accompanying drawings in which:

FIG. 1 shows a schematic diagram of a multi-RAT network architecture, according to one embodiment of the invention;

FIG. 2 shows a schematic diagram indicating a possible multi-RAT cell coverage, according to an embodiment of the invention;

FIGS. 3A to 3D show a signaling diagrams of different signaling options or alternatives according to one embodiment of the invention;

FIG. 4 shows a schematic block diagram of a signaling system according to one embodiment of the invention.

FIG. 5 shows a schematic block diagram of a computer-based implementation of the embodiment.

### DETAILED DESCRIPTION OF PREFERRED EMBODIMENTS

The invention, according to certain embodiments, will now be described based in an exemplary multi-RAT architecture in which an LTE access of 3GPP UTRAN, called E-UTRAN, is provided in combination with other RATs, such as 3G (e.g., UMTS) and/or 2G (e.g., GSM) technology. Multiple overlaid cells are operated, in which the different RATs are used in a common or shared administrative domain of the operator(s), and all cells are available for use by the terminal devices (e.g., UEs). However, it will be apparent from the following description and is therefore stressed that the invention can be applied to any other network architecture with different radio access technologies.

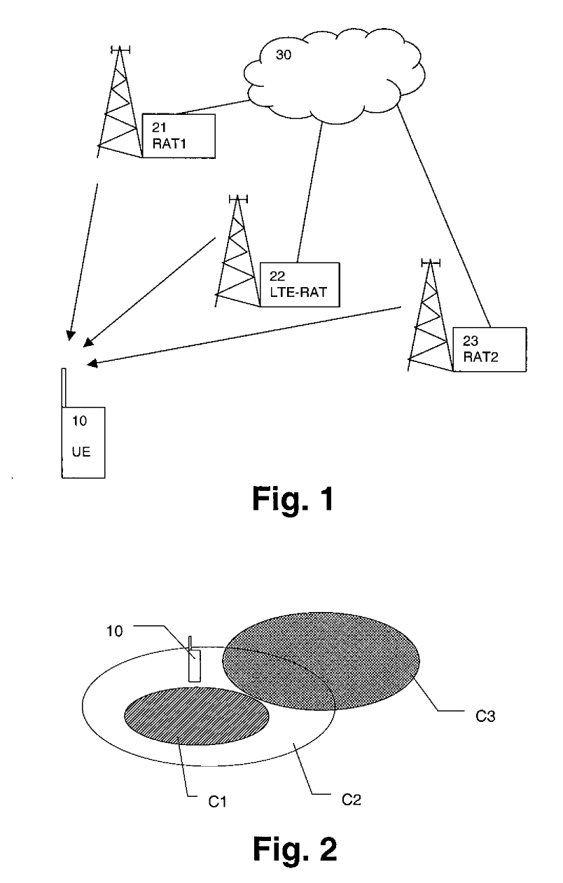

FIG. 1 shows a schematic diagram of the multi-RAT network architecture according to one embodiment of the invention. As an example, only three RAT access points (AP) 21 to 23 are shown, one of which is an LTE-RAT AP 22 which may be an enhanced Node B (eNB). The other two RAT APs 21 and 23 are based on a respective other access technologies RAT1 (e.g., a 3G technology) and RAT2 (e.g., a 2G technology), respectively. All RAT APs are network nodes or elements which terminate the respective RAT specific physical layer and optionally also some all RAT specific layer 2 functions, so as to provide access to a transport network 30 which may be based on a collection of network nodes or elements and/or devices which may share a common network control plane through which different cooperation levels in resource usage can be reached. The RAT AP 23 may be a GSM base transceiver station (BTS) which is coupled to the transport network 30 via a GSM base station controller (BSC) and a UMTS mobile switching center (MSC) or a GPRS (General Packet Radio System) Support Node (GSN). The RAT AP 21 may be an UTRAN node B which is coupled to the transport network 30 via a UTRAN radio network controller (RNC), and a UMTS MSC/GSN.

The different RAT APs 21 to 23 provide access for a terminal device 10 (e.g., mobile phones, UEs, or any other form of a variety of different wireless communication devices, such as a mobile radiotelephone, satellite radiotelephone, wireless networking card, or the like) as long as it is located within their respective cellular coverage areas.

FIG. 2 shows different cells C1 to C3 associated with the above RAT APs 21 to 23, respectively. Thus, the first cell C1 indicates the coverage area of the left RAT AP 21 with RAT1 technology (e.g., UTRAN), the second cell C2 indicates the coverage area of the left LTE RAT AP 22 with enhanced LTE access technology, and the third cell C3 indicates the coverage area of the right RAT AP 23 with RAT2 technology (e.g., GSM).

For interoperability, the terminal device 10 implements a process that controls selection and reselection of cells associated with the different RAT types, i.e., inter-RAT cell reselection. As an illustration, when the terminal device 10 is in the third cell C3 with a RAT2 (e.g., GSM) idle mode, it may perform signal measurements of the neighboring RAT1 (e.g., UTRAN) cell C1 or LTE cell C2. If the terminal device 10 determines that the neighboring cell C1 provides better signalling conditions, it selects the neighboring cell C1 with RAT1 technology for communication services.

Upon selection of the neighboring cell C1, the terminal device 10 switches to the RAT1 communication mode and attempts to “camp on” the RAT1 cell C1. To successfully camp on the RAT1 cell C1, however, the cell C1 must also satisfy other cell selection criteria. Exemplary cell selection criteria for UTRAN are specified foe example in the 3GPP Technical Specification (TS) 25.304. If the RAT1 cell C1 does not satisfy the cell selection criteria, the terminal device 10 deselects the RAT1 cell C1 and switches back to the RAT2 mode.

In such an overlaid multi-RAT environment, cell reselection criteria are of importance for efficient network operation. According to one embodiment of the invention, a service preference information is provided which indicates which RAT cell should be used for which service purpose of the terminal device 10 so that the utility of the network resources is balanced and optimum while providing high QoS to the terminal device 10 and avoiding inter-RAT handover as much as possible.

From the operators' perspective, LTE access technology is rather used to deliver “new” services with good enhancements in terms of cost, quality and security, which are highly valued by the customers. The following service class table summarizes the LTE service classes for business requirements of the operators:

| Service Classes Supported by LTE | Driver for LTE |
|---|---|
| Synchronous Services: | |
| Voice (e.g., VoIP, PoC) | Med |
| Video Telephony | High |
| Multimedia conferencing | High |
| Legacy Messaging Services: | |
| SMS | Low |
| MMS | Low |
| Real Time Messaging: | |
| Instant Messaging Services | High |
| Streaming Services: | |
| Audio | Med |
| Video | High |
| Asynchronous Services: | |
| Internet-Like Services | |
| Slow Interactive Sessions | Med |
| Fast Interactive Sessions | High |
| Download video/audio | Med |
| Web browsing (per page) | Med |
| High priority E-commerce | High |
| Email (Internet) | Med |
| Email (VPN) | High |
| Voice mail | |
| Voice mail access | Low |
| m2m services | |
| Telemetric (background - one way) | High |
| Trust Based Services: | |
| Security, Safety & Dependability | High |
| (e.g., VPN or transactional/virus | |
| or SPAM protection/ | |
| Guaranteed Quality of Service) | |
| Broadcast or Multicast Services: | |
| (e.g., public safety alarms, sport highlights, TV) | High |

Based on the above considerations, certain embodiments, as described below, provide a simple and effective means of signaling service-based cell-reselection criteria to the terminal. This enables the network to control the terminal device 10 to access a suitable RAT cell for a certain service in the overlaid multi-RAT environment. This option can be used as a service-based condition for triggering an inter-RAT handover as well.

In the following, it is assumed that the broadcast system information provided by the network to the terminal device 10 contains some information about the overlaid multi-RAT environment. Furthermore, the LTE cell C2 is assumed to be also able to support all kinds of packet services.

According to one embodiment of the invention, the LTE network indicates to the terminal device 10 preferences on service classes (and applications) which should be served with LTE and different RAT cells. For example, services marked as LTE high driver in the above table could be associated to LTE RAT at the first place and other services to the other RATs, e.g., RAT1 and RAT2.

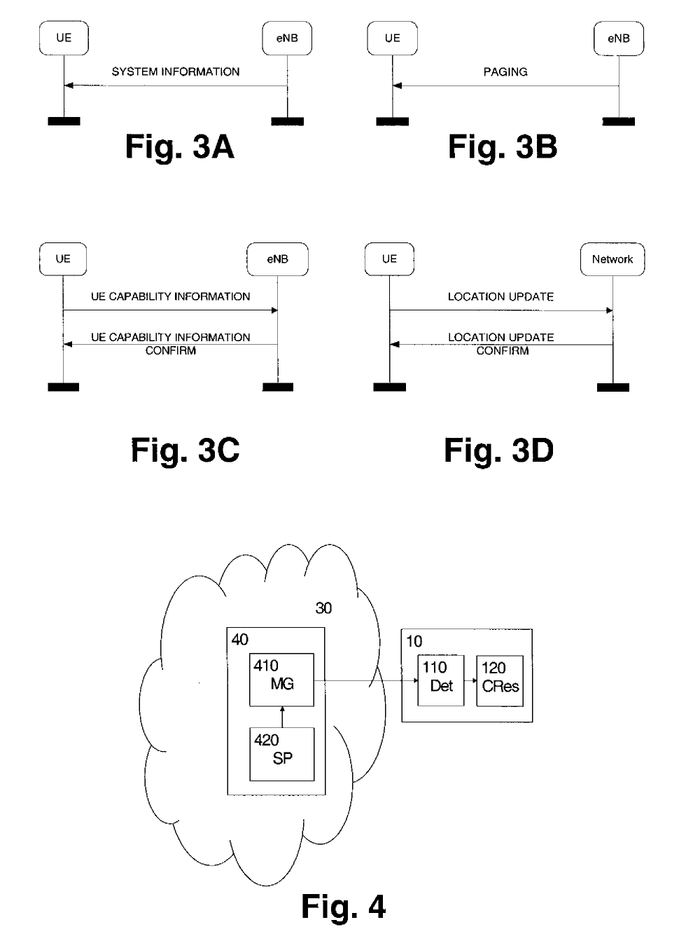

FIG. 3A shows a first implementation example, where a service preference information is signaled from the LTE AP 22 (e.g., eNB) as a broadcast information to the terminal device 10 (e.g., UE). As an example, this broadcast information may be a system information which contains or has embedded the service preference information as an information element “preferred service classes” of information group “cell selection and reselection” of an E-UTRAN information. It can be recommended or signaled to all terminal devices in the broadcast information system, specific to each RAT. In this way the information is valid to all terminal devices.

FIG. 3B shows a second implementation example where signaling is performed on a per-call basis. Here, the service preference information indicating the preferred RAT is included or embedded in a paging message, e.g., when the terminal device 10 is paged for an incoming call. The per-call control can be more specific, so that the network can inform the terminal device 10 about the most preferable RAT which should be selected in order to answer the incoming call. Here, the service preference information can be signaled in an information element “preferred RAT info for cell reselection” of the paging record.

For a network-originated call to the terminal device 10 in idle mode, the terminal device 10 will be paged first via the current RAT cell in which its idle state has been maintained. This may result in an inter-RAT handover triggered by the expected service. But the network can prepare the inter-RAT handover beforehand to reduce the call setup delay.

FIG. 3C shows a third implementation example where signaling is performed on a per-location basis. Here, the service preference information indicating the preferred RAT is signaled during capability negotiation where the terminal device 10 negotiates multi-RAT capabilities with the network system. In this scenario, the terminal device 10 indicates its multi-RAT capabilities to the network in a UE capability information message. The network responds with a UE capability information confirmation message which may include or have embedded the proposed service preference information as a cell selection or reselection information. It is assumed here that the network is operating on multi-RAT environment with certain or full awareness.

FIG. 3D shows a fourth implementation example where signaling is also performed on a per-location basis. Here, the service preference information indicating the preferred RAT is signaled during location update. In this scenario, the terminal device 10 signals a location update request to the network. The network responds with a location update confirmation message which may include or have embedded the proposed service preference information as a cell selection or reselection information. It is again assumed that the network is operating on multi-RAT environment with certain or full awareness.

Thus, in the second to fourth implementation examples, signaling to individual terminal devices can be performed during initial access or registration to a new administrative domain. This way, the subscription profile of the terminal device 10 can be taken into account to configure some QoS differentiation right at this stage. For a terminal-originated call from the terminal device 10 in the idle mode, the terminal device 10 can now use the aforementioned service preference information and the service awareness of the upcoming call to perform cell reselection if needed for using the appropriate RAT. For instance, the terminal device 10 reselects the LTE RAT cell C2 for the LTE-driver services indicated in the above table.

Due to the fact that cells with 3G and enhanced 3G (e.g., LTE) RATs may overlap as indicated in FIG. 2, the above proposed signalling procedure can be applied for any type of RAT by using suitable messages (e.g., radio resource control (RRC) messages) into which the above service preference information can be embedded as information element or the like.

FIG. 4 shows schematic block diagrams of a network element 40 which may be part of the transport network 30 or which may correspond to one of the RAT APs 21 to 23 indicated in FIG. 1 and adapted to provide the proposed signalling function according to one embodiment of the invention.

According to FIG. 4, the network element 40 comprises a service preference table or memory 420 in which preferred RATs are allocated to different service types which can be offered via the network 30. As an example, the service preference information stored in the service preference memory 420 may be based on the above service class table, and may be set by the operator(s) of the different RATs provided in the multi-RAT architecture.

Based on the information provided in the service preference memory 420, a message generation functionality 410 embeds or adds the specific service preference information e.g., as information element to individual messages, such as those described in connection with FIGS. 3A to 3D, so as to be signaled to the terminal device 10.

At the terminal device 10, a detection functionality 110 is provided for detecting and interpreting the service preference information added to or embedded in the respective message, and for providing the detected service preference information to a cell selection or reselection functionality 120 configured to initiate a cell selection, reselection or inter-RAT handover based on the detected service preference information.

At this point, it is noted that the functionalities of blocks 110, 120, 410 and 420 described in connection with FIG. 4 may be implemented as discrete hardware or signal processing units, or alternatively as software routines or programs controlling a processor or computer device to perform the processing steps of the above functionalities.

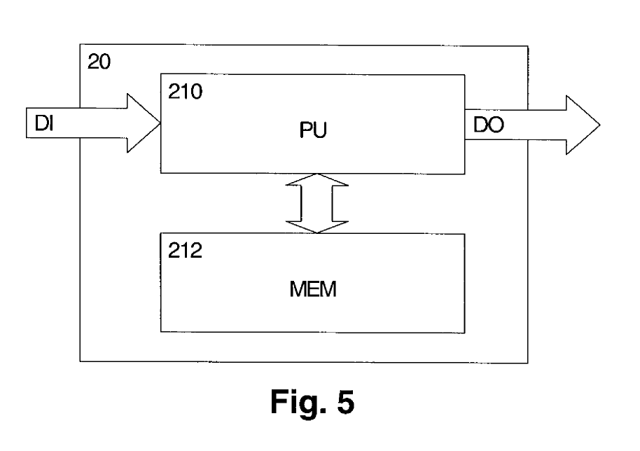

FIG. 5 shows a schematic block diagram of a software-based implementation of the network side and the terminal side. Here, the network element 40 and/or the terminal device 10 each comprise a processing unit 210, which may be any processor or computer device with a control unit which performs control based on a software routines of a control program stored in a memory 212. Program code instructions are fetched from the memory 212 and are loaded to the control unit of the processing unit 210 in order to perform the processing steps of the above functionalities described in connection with FIG. 4. These processing steps may be performed on the basis of input data D1 and may generate output data D0, wherein the input and output data D1, D0 may related to the control signaling required at the respective functionality.

Hence, a flexible and rather straightforward signalling option is provided which can be embedded into or added to broadcast system information, UE capability negotiation, or network policy enforcement during initial access and registration or during other suitable opportunities.

To summarize, methods, a system, a network element, a terminal device, and computer program products have been described for cell selection or reselection in a multi-radio network environment involving at least two different radio access technologies. A service preference information which indicates service preferences for different radio access technologies can be set at a network element and can be sent to at least one terminal device. At the terminal device, the service preference information is detected and a serving cell is selected based on the detected service preference information. Thereby, the network is capable of performing service-based control of cell selection or reselection of the terminal device upon initiating access for a certain service in an overlaid multi-RAT environment. This in turn enhances network utility, operation and performance.

It is to be noted that the invention is not restricted to the embodiment described above, but can be implemented in any network environment involving different radio access technologies which can be used selectively. Any signaling means or message can be used for transferring the service preference information to a terminal device. The service preference information may even be obtained based on a retrieval, download or access operation initiated by the terminal device. The embodiment may thus vary within the scope of the attached claims.

1. A method comprising:
detecting at a terminal device a service preference information indicating service preferences for different radio access technologies; and
selecting based on said detected service preference information a serving cell out of at least two available cells of different radio access technologies.

2. The method according to claim 1, wherein said service preference information is detected in at least one of a received broadcast system information, a capability information confirmation received during a negotiation procedure, a received location update confirmation, and a received paging message for an incoming call.

3. The method according to claim 1, wherein said service preference information is detected in an information element of a radio resource control message.

4. The method according to claim 1, wherein said service preference information indicates service-dependent priority of a first radio access technology over at least one a second radio access technology.

5. The method according to claim 1, wherein said selection is configured to trigger an inter-radio access technology handover.

6. A method comprising:
setting at a network element a service preference information indicating service preferences for different radio access technologies; and
signaling said service preference information to at least one terminal device.

7. The method according to claim 6, wherein said service preference information is embedded in at least one of a broadcast system information, a capability negotiation with said terminal device, a network policy enforcement during initial access and registration, a location update confirmation, and a paging message for an incoming call.

8. The method according to claim 6, wherein said service preference information is conveyed in an information element of a radio resource control message.

9. The method according to claim 6, wherein said service preference information indicates service-dependent priority of a first radio access technology over at least one a second radio access technology.

10. The method according to claim 6, further comprising preparing an inter-radio access technology handover before call set-up.

11. A network element comprising:
setting means for setting a service preference information indicating service preferences for different radio access technologies; and
signaling means for signaling said service preference information to at least one terminal device.

12. The network element according to claim 11, wherein said signaling means is configured to embed said service preference information in at least one of a broadcast system information, a capability negotiation with said terminal device, a network policy enforcement during initial access and registration, a location update confirmation, and a paging message for an incoming call.

13. The network element according to claim 11, wherein said signaling means is configured to convey said service preference information in an information element of a radio resource control message.

14. The network element according to claim 11, wherein said service preference information indicates a service-dependent priority of a first radio access technology over at least one a second radio access technology.

15. A terminal device comprising:
detecting means for detecting in a downlink signal a service preference information indicating service preferences for different radio access technologies; and
selecting means for selecting based on said detected service preference information a serving cell out of at least two available cells of different radio access technologies.

16. The terminal device according to claim 15, wherein said detecting means is configured to detect said service preference information in at least one of a received broadcast system information, a capability information confirmation received during a negotiation procedure, a received location update confirmation, and a received paging message for an incoming call.

17. The terminal device according to claim 15, wherein said detecting means is configured to detect said service preference information in an information element of a radio resource control message.

18. The terminal device according to claim 15, wherein said service preference information indicates a service-dependent priority of a first radio access technology over at least one a second radio access technology.

19. The terminal device according to claim 15, wherein said selecting means is configured to trigger an inter-radio access technology handover.

20. A network system comprising:
at least two radio access networks using different radio access technologies; and
at least one network element according to claim 11.

21. A network system comprising:
at least two radio access networks using different radio access technologies; and
at least one terminal device according to claim 15.

22. A computer program product comprising code means for producing the steps of method claim 1 when run on a computer device.

23. A computer program product comprising code means for producing the steps of method claim 2 when run on a computer device
